(19) United States
(12) Patent Application Publication
(10) Pub. No.: US 2010/0079993 A1
(43) Pub. Date: Apr. 1, 2010

(54) DECORATIVE LIGHT STRING

(76) Inventor: Richard Kinderman, Philadelphia, PA (US)

Correspondence Address: Connolly Bove Lodge & Hutz LLP, P.O. Box 2207, Willmington, DE, 19899-2207, US

(21) Appl. No.: 12/566,721

(22) Filed: Sep. 25, 2009

Related U.S. Application Data
(60) Provisional application No. 61/100,833, filed on Sep. 29, 2008.

(51) Int. Cl. F21V 1/00; F21S 4/00

(52) U.S. Cl. 362/237; 362/249.06; 362/277

(57) ABSTRACT

A decorative light string comprises a plurality of spaced illuminatable LED light bulbs which are interconnected by an electrically conductive string having a plug for providing the power to illuminate the bulbs. Each bulb has a cap mounted to the conductive string. The cap has a portion made of a transparent/translucent material to permit light to pass therethrough. The cap also has a light blocking portion to reflect and concentrate the light passing through the light bulb. The same features could be included in an individual LED light bulb for industrial, commercial or home usage.

### CROSS-REFERENCE TO RELATED APPLICATION

This application is based on provisional application Ser. No. 61/100,833, filed Sep. 29, 2008, all of the details of which are incorporated herein by reference thereto.

### BACKGROUND OF INVENTION

Light strings have been commonly used for indoor or outdoor usage such as during the holiday season to provide decorative lighting for the exterior of homes, buildings, trees, etc., and for indoor decorative lighting commensurate with a holiday season, such as for providing green and red lights for the Christmas season. It would be desirable to improve the effectiveness of operation of such light strings.

It would also be desirable to improve the effectiveness of LED light bulbs for use as individual bulbs in home and industry.

### SUMMARY OF INVENTION

An object of this invention is to provide a decorative light string incorporating LED bulbs which are capable of creating brighter and more evenly diffused lights than conventional light strings.

A further object of this invention is to provide such a decorative light string which may incorporate conventional technology with improvements thereto to thereby improve the results from the light string.

A still further object of this invention is to improve the brightness and effectiveness of LED bulbs for uses apart from decorative light strings.

In accordance with one practice of this invention a light string comprises a plurality of spaced illuminatable LED light bulbs which are interconnected by an electrically conductive string, A plug is mounted to the string for providing the power to illuminate the light bulbs, Each of the light bulbs has a transparent/translucent light transmitting portion so that light may readily pass therethrough. Each bulb additionally has a light blocking portion which may be a reflective inner surface to reflect and concentrate the light before it passes through the light transmitting portion.

In one practice of the invention the light transmitting portion may be a cap which is attached to a base. The base may be in the form of a reflector cup whose inner surface functions as light blocking structure. In this example of a practice of the invention the base may preferably comprise about the lower quarter of the bulb and terminate in a circular rim which is mounted against the circular rim of the cap. Preferably, the cap is made of a plastic material while the base is metallic. Other materials may also be used.

In another practice of the invention the size and location of the light blocking portion may be adjustable.

The concepts of this invention may be applied to LED bulbs or fixtures housing LED lights which are individually bulbs and not necessarily part of a light string.

### THE DRAWINGS

FIG. 1 shows a decorative light string in accordance with this invention;

FIG. 2 shows one of the bulbs of the light string of FIG. 1 on an enlarged scale and partially in section;

FIG. 3 is a view similar to FIG. 2 of an alternative practice of this invention; and

FIG. 4 is a view taken along the line 4-4 of FIG. 3.

### DETAILED DESCRIPTION

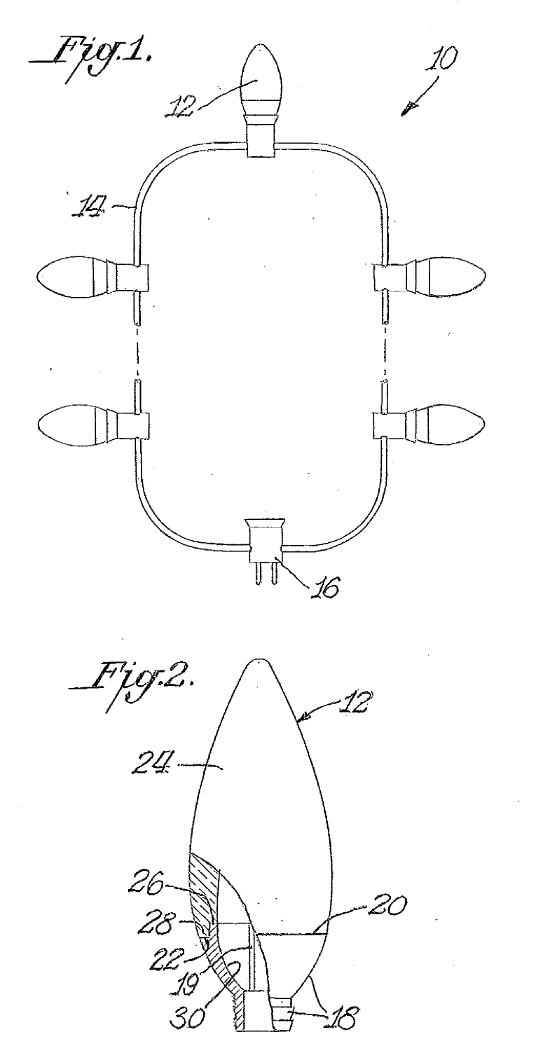

FIG. 1 illustrates a light string 10 in accordance with one practice of this invention. As shown therein, the light string 10 includes a plurality of light bulbs or caps 12 interconnected by an electrically conductive string 14. A plug 16 is mounted to the string. When the plug is connected into the household power the light bulbs are illuminated as is known in the art.

FIG. 2 shows the details of a bulb which also illustrates the features of this invention which distinguish over conventional practices. It is to be understood that the following description of the embodiment shown in FIG. 2 is intended for illustrative purposes and is not intended to be limiting. FIG. 2 shows an LED bulb which would have a small diode chip that sits inside the bottom of a cap. For reference purposes the LED light bulb with its outer cap will simply be referred to as cap 12. As shown in FIG. 2 the cap 12 has a base 18 which would be electrically connected to the conductor 14. The illustrated cap 12 is an LED light bulb which includes known construction, such as cathode 19, for illuminating the cap. The base 18 terminates in a circular rim 20 having an outward annular shoulder 22. Bulb 12 also includes an outwardly extending light transmitting portion 24 having a circular rim of mirror image shape to the circular rim of base 18. In that regard, portion 24 has its annular shoulder 26 inwardly of its rim 28 for snugly fitting against the corresponding rim 20 and outer shoulder 22 of base 18. Base 18 and portion 24 are secured together in any suitable manner that is known in the art.

Light transmitting portion 24 may be of any suitable desired and known shape such as the illustrated tear-drop shape or can be a generally ball shape or of any other desired shape. Portion 24 is made of a transparent or translucent material so that when cap 12 is illuminated the light may readily pass through portion 24. If desired, portion 24 could be made of a colored material, as is known.

Base 18 could screw into or otherwise be mounted to a receptacle in conductive string 14 in any known suitable manner which would result in the cap 12 becoming illuminated.

In the illustrated embodiment of FIG. 2, base 18 is in the form of a generally cylindrical bottom portion which would be connected to the conductive string 14 and then terminates in an outwardly expanding cup shape which merges with the inwardly tapered shape of portion 24. The inner surface 30 of base 18 and the inner surface of cap 24 are illustrated as being smooth continuous curves. The inner surface, however, need not be smooth and need not be curved.

A key feature of the invention is that the cap 12 includes a light blocking portion. Preferably the light blocking portion is in the form of a reflective coating on the inner surface of that portion of cap 12 so that the light is directed and diffused through the light transmitting portion in such a manner that the light is brighter and more evenly diffused than might otherwise be expected. The light blocking function can be achieved from providing a reflective coating on the inner surface of a suitable portion of cap 12, such as on the inner surface of the base 18. A light blocking surface could also be obtained, for example, from the use of grey paint on the inner surface. It is to be understood that although FIG. 2 illustrates cap 12 to be of two piece construction in the sense of a separate light transmitting portion and a separate base, the invention could be practiced where cap 12 is made of one piece construction with an appropriate portion having the light blocking inner surface. It is also to be understood that although the invention has been described in terms of incorporating an LED bulb in a decorative light string, the invention could be practiced with an individual LED bulb used for any purpose such as in industry or home use and need not be part of a decorative light string. Where used for such other purposes a single LED bulb could be used such as for a street light. Alternatively, a series of individual LED bulbs could be used such as for ceiling lighting where the bulbs are totally separate and distinct from each other each with its own power connection or where the bulbs might even be mounted in a string fashion, although not intended necessarily to be used as a decorative light string.

While the invention could be practiced with a reflective surface such as a reflective silver surface at the light blocking portion, the invention could also be practiced with any suitable light blocking surface which would block the light in the sense of preventing the light being filtered out so that the light could be concentrated and thereby result in a brighter, more evenly diffused light.

In the embodiment of the invention illustrated in FIG. 2, base 18 has a reflective inner surface 30, such as being a reflective silver surface. The reflective inner surface causes light to bounce forward at, for example, an angle of about 60-80° thus concentrating the light, but with a narrower angle than is obtained with most traditional LEDs. The provision of the base or reflector cap 18 not only concentrates the light at a narrow angle, but also results in a bulb which should be brighter than the average LEDs with more evenly diffused light and which uses less energy thereby reducing greenhouse effects. The light blocking portion, which is preferably reflective, also captures leaking light.

Light transmitting portion 24 may be made of any suitable known material and is preferably made of a plastic material such as an acrylic. Where made of such a plastic material there is no glass bulb to break and the bulb is cool to touch. Preferably portion 24 occupies at least one-half and more preferably at least two thirds and most preferably about three quarters of the overall length of the cap 12 with base 18 thereby occupying the remaining portion of the cap. Base 18 thus most preferably comprises about the bottom quarter of the cap length and is preferably made in the form of a metallic reflector cone or cup rather than being made of a material such as an acrylic material as is conventionally done. The invention, however, can be practiced with materials other than metal, including acrylic or other plastics. As previously noted, the light blocking surface can be achieved by any suitable material which would prevent light from filtering out to thereby concentrate the light passing through the light transmitting portion 24. Such light blocking surface could be achieved by painting the inner surface of a suitable portion of cap 12 with a reflective paint or with a grey paint or by providing any other suitable substance, preferably a reflective substance on the inner surface of the light blocking portion of cap 12. In a preferred practice of this invention the reflector base 18 would have its inside total shining silver, with an electro-plated inside and outside.

Cap 12 could be made of any suitable size and shape. In the embodiment illustrated in FIG. 2, for example, where cap 12 has an overall length of 33.13 mm, portion 24 could be 24.63 mm long, while base 18 could be 9.5 mm long with the portion 24 and base 18 overlapping at their rims a distance of 1.2 mm. The rim 20 of base 18 could have an inside diameter of about 9.5 mm with the outside diameter being 7.3 mm. The lowest portion of base 18 which is of generally cylindrical shape could have a diameter of 5.3 mm and a length of 3 mm. The inside diameter at the open end of portion 24 could be about 8 mm with the diameter from the outer portion of the shoulder being about 9.5 mm to mate with that portion of the rim of base 18. In this example of the cap 12, the base 18 comprises about 29% of the overall length of cap 12. Preferably, base 18 comprises no more than the bottom third of the overall length of cap 12 and most preferably about the bottom quarter of the overall length of cap 12. The inner surface of cap 12 has a smooth continuous transition from the base to the light transmitting portion 24 which enhances the effectiveness of reflecting the light from the inner surface of base 18 upwardly into the portion 24 and outwardly through the portion 24.

The light string 10 may include any suitable number of bulbs or caps 12, such as 25 bulbs spaced 8 inches or 12 inches apart. The string 10 could have any suitable length, such as being 25 feet or 50 feet long. String 10 could be designed to operate with a 5 amp or 3 amp fused plug which would be inserted directly into the household power.

It is to be understood that the dimensions in the above specific example are merely intended to be illustrative of one practice of the invention.

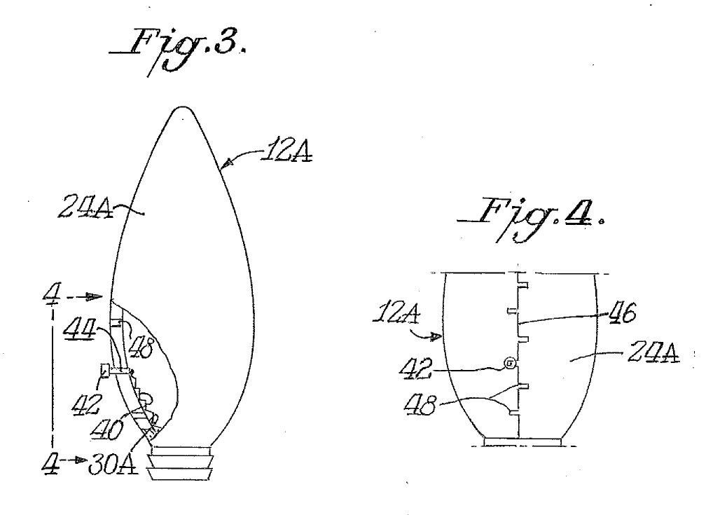

FIGS. 3-4 illustrate a further embodiment of this invention wherein the cap 12A includes a light transmitting portion 24A and base which are of one piece construction. The light blocking portion of cap 12A is provided on an inner surface, 30A. Such light blocking portion could be achieved as in the embodiment of FIG. 2 by providing a reflective or other light blocking coating on inner surface 30A.

FIGS. 3-4 illustrate a variation of the invention wherein the user may adjust or control the size or amount of light blocking portion. Basically, this could be done by having some material, such as a sheet or layer 40 made of light blocking material disposed against the inner surface 30A. By moving the layer 40 upward or downward there is a corresponding adjustment in the size and position of the light transmitting portion 24A of cap 12 and of the corresponding light blocking portion 40. Any suitable techniques could be used for moving the layer 40. In the illustrated embodiment of FIGS. 3-4 the layer 40 is made of a stretchable and/or accordion type sheet so that it can be raised or lowered. A handle 42 may be mounted externally of cap 12A and may be connected to layer or sheet 40 in any suitable manner. For example, in the embodiment illustrated in FIGS. 3-4 handle 42 is in the form of a knob having a shaft 44 which extends through a sealed slit 46. Thus, by moving the knob 42 upwards or downwards the light blocking layer 40 is correspondingly moved upwards or downwards. Although a single handle is illustrated, more than one handle can be provided. As shown in FIG. 4 the sealed slit 46 could have offset portions 48 into which the shaft 44 would be moved to lock the handle in place.

As previously noted the concepts of this invention readily lend themselves to the utilization of LED bulbs in a decorative light string. The same concepts, however, could also be applied to individual LED bulbs used as a single bulb or in combination with other individual bulbs to provide light for various industrial, commercial or home purposes.

What is claimed is:

1. A decorative light string comprising a plurality of spaced illuminatable LED light bulbs, said light bulbs being electrically interconnected by an electrically conductive string, an electrical plug mounted to said conductive string for powering said light bulbs to illuminate said light bulbs, said light bulbs comprising a cap having a transparent/translucent light transmitting portion to permit light to pass therethrough, and said cap having a light blocking portion to concentrate the light passing through said light transmitting portion.

2. The light string of claim 1 wherein said cap has a lower end, and said light blocking portion being located at said lower end of said cap.

3. light string of claim 2 wherein said lower end of said cap has a reflective inner surface which comprises said light blocking portion.

4. The light string of claim 2 wherein a base mounted to said lower end of said cap, and said light blocking portion being on an inner surface of said base.

5. The light string of claim 4 wherein said light transmitting portion is made of a plastic material and said base is made of a metallic material.

6. The light string of claim 4 wherein said light blocking portion comprises a silver reflective inner surface of said base.

7. The light string of claim 4 wherein said base and said light transmitting portion are of unitary one piece construction.

8. The light string of claim 3 wherein said reflective inner surface causes light to bounce forward at an angle of about 60-80°.

9. The light string of claim 1 wherein the positioning of said light blocking portion is adjustable to adjust the relative size of said light transmitting portion and of said light blocking portion.

10. In an LED light bulb having a cap which includes a light transmitting portion made from a transparent/translucent material to permit light to pass therethrough, the improvement being in that said cap has a light blocking portion to concentrate the light passing through said light transmitting portion.

11. The LED light bulb of claim 10 wherein said cap has a lower end, and said light blocking portion being located at said lower end of said cap.

12. The LED light bulb of claim 11 wherein said lower end of said cap has a reflective inner surface which comprises said light blocking portion.

13. The LED light bulb of claim 12 wherein a base mounted to said lower end of said cap, and said light blocking portion being on an inner surface of said base.

14. The LED light bulb of claim 13 wherein said light transmitting portion is made of a plastic material and said base is made of a metallic material.

15. The LED light bulb of claim 13 wherein said light blocking portion comprises a silver reflective inner surface of said base.

16. The LED light bulb of claim 13 wherein said base and said light transmitting portion are of unitary one piece construction.

17. The LED light bulb of claim 12 wherein said reflective inner surface causes light to bounce forward at an angle of about 60-80°.

18. LED light bulb of claim 10 wherein the positioning of said light blocking portion is adjustable to adjust the relative dimensions of said light transmitting portion and said light blocking portion.
